(19) United States
(12) Patent Application Publication
(10) Pub. No.: US 2002/0003535 A1
(43) Pub. Date: Jan. 10, 2002

(54) Image processing system and method

(76) Inventor: llu Cho, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 09/865,292

(22) Filed: May 25, 2001

(30) Foreign Application Priority Data
May 26, 2000 (JP) 2000-157252

(51) Int. Cl. G09G 5/00

(52) U.S. Cl. 345/204

(57) ABSTRACT

The present invention provides an image processor including a model designation controller for designating a model type of a portable terminal to which an image is be displayed. The image processor also includes a screen format controller for determining at least one screen format among a plurality of screen formats of the designated model, a data capacity and data format of the image. The image processor further includes an image adjuster for adjusting the image, and a transmitter for transmitting the adjusted image to a server to which the portable terminal of a receiving party has access.

### BACKGROUND OF THE INVENTION

1. Field of the Invention

The present invention relates to an image processing system and method. In particular, the present invention relates to an image processing system and method for processing and transmitting an image to a portable terminal.

2. Related Art

Recently there has been an explosion in the use of portable phones. The increase in portable phone use has been accelerated with the incorporation of services which provide services such as transmitting images to be displayed or musical tones played on the portable phone through the Internet. With the wide spread use of portable phones, various businesses providing these services for portable phones have been created. For example, a standby screen service provider has been recently established which transmits an image to a subscriber to be used as a screen standby when the portable phone is an idle or inactive state. The image is used in a similar manner as a screen saver image for personal computer. In this service, a service provider stores an image for a subscriber and then sends the subscriber an email of the Web site where the image is stored. The image is stored in a location located by the forwarded Web site address in a designated server. The subscriber can obtain the image by entering the Web site address. The above-mentioned service is a popular service with users who desire a portable phone's standby screen for themselves or their friends.

However, the above-mentioned service has several disadvantages. One disadvantage is that sometimes a transmitted image does not fit in the screen display of the receiving party's portable phone. Portable phones vary in size and shape depending on the maker or the model of the portable phone. As such, the transmitted image may extend beyond the portable phone's screen display and sometimes cannot be used as a standby image. Alternatively, there are instances where the transmitted image is not aesthetically pleasing because the image is too small for the screen display and incorporates unnecessary spaces in the screen display of the portable phone. In order to prevent misalignment of transmitted images for the screen display of portable phones, it is necessary to verify the size of the portable phone's screen display or to transmit a plurality of images having varying sizes. However, this approach is troublesome, and costly and leads to a decrease in the number of the subscribes to the service. Although an automatic resizing function incorporated with portable phones which fits the image on the screen display is available; this resizing function blurs the image by stretching the image to fit in the screen display. This too provides an image that is not visually pleasing.

Another disadvantage of the above-mentioned service is the risk of an authorized user obtaining access to the stored image. Although the service provider notifies the authorized user (subscriber) of the Web address where the image is stored, via the authorized user's portable phone, if the notified authorized user does not download the image but instead leaves the image available for a long period of time, there is a possibility that an unauthorized user may gain access to the image.

Further, another disadvantage of the screen is that the image can not be processed when it has been downloaded to a portable terminal and it is desirable to process the image in relation to the design of the portable terminal or a receiving party's preference. When the portable terminal is a portable phone, the portable phone is limited in terms of cost and size, compared to a personal computer since it is difficult to install software or hardware for image processing on portable phones. Accordingly, the user needs to retransmit the desired image or ask the transmitter to transmit another image. Therefore, image transmission/receipt becomes cumbersome and inefficient.

Moreover, although transmission of the exact same image to a plurality of people is possible, it is impossible to transmit images that have been slightly modified or varied to each person.

In view of the above disadvantages the invention provides an image processing system and method capable of transmitting an image so as to fit in the screen display of a portable phone of a receiving party. Moreover, the present invention provides an image processing system capable of sending an image safely to the receiving party. The present invention also makes it possible to process an image as the receiving party desires without requiring the receiving party's portable phone to have image processing capabilities. Moreover, the present invention is capable of transmitting images to a plurality of people with each image sent having minor alternations.

### SUMMARY OF THE INVENTION

In accordance with one embodiment of the present invention an image processor includes a model designation controller for designating a model type of a portable terminal to which an image is be displayed. The image processor also includes a screen format controller for determining at least one screen format among a plurality of screen formats of the designated model, a data capacity and data format of the image. The image processor further includes an image adjuster for adjusting the image, and a transmitter for transmitting the adjusted image to a server to which the portable terminal of a receiving party has access.

Other features and advantages of the invention will be apparent from the following description, taken in conjunction with the accompanying drawings that illustrate, by way of example, various features of embodiments of the present invention.

### BRIEF DESCRIPTION OF THE DRAWINGS

FIG. 1 shows a network system including a first embodiment of an image processor according to the present invention;

FIG. 2 shows the image processor of FIG. 1 in greater detail;

FIG. 3 shows a flow diagram for subscriber registration of an image providing service;

FIG. 4 shows a virtual portable terminal displayed when a program starts in the image processor of FIG. 1;

FIG. 5 shows the image inputting work with the virtual portable terminal as shown in FIG. 4;

FIG. 6(A) shows a screen for selecting the model of the portable terminal in the virtual portable terminal when a size key is pressed as shown in FIG. 4;

FIG. 6(B) shows a screen display for selecting the model of the portable terminal in the virtual portable terminal with different models displayed from the screen;

FIG. 7 shows a screen display of a list key being pressed;

FIG. 8 shows a screen display of a send confirmation key being pressed from the screen of FIG. 7;

FIG. 9 shows a flowchart of the image processing and the transmitting process of the image processor shown in FIG. 1;

FIG. 10 shows an embodiment of the server for image providing shown in FIG. 1;

FIG. 11 shows a flowchart of the image processing process and transmission at the user's terminal to the image being transmitted to a receiver's portable phone by the network system of FIG. 1;

FIG. 12 shows a URL formed by an address forming means in the process shown in FIG. 11;

FIG. 13 shows a monthly subscription user making alternations in subscriber data or cancellation in the network system of FIG. 1;

FIG. 14 shows a network system according to a second embodiment of the present invention;

FIG. 15 shows the server (image processor) shown in FIG. 14;

FIG. 16 shows a flow diagram of the registration process for registering the user with the server of FIG. 15;

FIG. 17 shows a flow diagram of the process in which the server of FIG. 15 receives data of an image (the original image) from the user's terminal;

FIG. 18 shows a diagram of the process in which the original image and the processed image are received by another user via a portable phone of FIG. 14 from the server of FIG. 15;

FIG. 19 shows a flow diagram of the process in which the user's terminal of FIG. 14 obtains terminal version information from the server of FIG. 15;

FIG. 20 shows the process of processing the original image received by another user via the portable phone of FIG. 14 to have a screen with different colors at the server of FIG. 15 and receiving the processed images once again; and

FIG. 21 shows the process in which the server of FIG. 15 transmits a plurality of processed images obtained by subjecting different processes to the original image in each of the portable phones.

### DETAILED DESCRIPTION OF THE INVENTION

One embodiment of the present invention relates to an image processor, an image processing method, an image processing system and an information recording medium and will be explained based on the drawings. While the description of this embodiment refers to a portable terminal as a portable phone by way of example, it will be appreciated by those skilled in the art that the portable terminal can be any device, for example a mobile computer.

One embodiment of the present invention provides an image processor including a model designator for designating a model type of a portable terminal to which an image is be displayed, a screen format controller for determining at least one screen format among a plurality of screen formats of the designated model, a data capacity and a data format of the image, an image adjuster for adjusting the image, and a transmitter for transmitting the adjusted image to a server to which a portable terminal of a receiving party has access.

The image processor may include a virtual portable terminal display for displaying a virtual portable terminal and a screen display for displaying a screen format of the virtual portable terminal according to the screen format which has been determined by the screen format controller, wherein the image adjuster adjusts the image in accordance with the screen format of the virtual portable terminal. The image adjuster also surrounds and adjust the image.

According to one embodiment of the present invention, the portable terminal is a portable phone and the virtual portable terminal is a representation of a portable phone.

The image processor may also include an image formatting controller for formatting an image to fit in the screen display of the portable terminal of the receiving party, a storage device for storing the image as a file designated by a URL; a transmitter for transmitting the file to the portable terminal of a receiving party; and a file formatting controller for forming a file designated by a URL with the file including an image and information magnifying or reducing the image to fit in the screen display of the portable terminal of the receiving party.

According to one embodiment of the present invention, the transmitter transmits a URL to a subscriber that created the image as well as transmits the URL to an address specified by the subscriber.

According to an embodiment of the present invention, the image processor further includes a storage device for storing the image as the one transmitted to the portable terminal of the receiving party.

According to another embodiment of the present invention, an image processing method includes a model designation step for designating a model type of a portable terminal of a receiving party to which an image is to be transmitted, a screen formatting determination step for determining at least a screen format among a plurality of screen formats of the designated model, a data capacity and data format of the image, an image adjusting step for adjusting the image to be transmitted, and a transmitting step for transmitting the adjusted image to a server to which the portable terminal of the receiving party has access.

The method also includes a virtual portable terminal display step for displaying a virtual portable terminal according to the screen format which has been determined by the screen format determination step, wherein in the image adjustment step the image to be transmitted is adjusted in accordance with the screen format of the virtual portable terminal; an image forming step for forming an image to fit within the screen display of the portable terminal of the receiving party; a storing step of storing the image as a file designated by a URL, a transmitting step of transmitting the file to the portable terminal; and a file forming step for forming a file designated by a URL with the file including the image and information capable of magnifying or reducing the image to fit within the screen display of the portable terminal of the receiving party.

According to another embodiment of the image processing method of the present invention, a URL is transmitted to a subscriber that created the image as well as transmitted to the address specified by the subscriber in the transmitting step.

The method further includes a storage step of storing the image as the one transmitted to the portable terminal of the receiving party.

According to another embodiment of the present invention an information recording medium having a program stored thereon includes a model designation step for designating a model type of a portable terminal of a receiving party to which an image is to be transmitted, a screen formatting determination step for determining at least one screen format among a plurality of screen formats of the designated model, a data capacity and data format of the image, an image adjusting step of adjusting the image to be transmitted, and a transmitting step for transmitting the adjusted image to a server to which the portable terminal of the receiving party has access.

The method also includes a virtual portable terminal display step for displaying a virtual portable terminal according to the screen format which has been determined by the screen format determination step, wherein in the image adjustment step the image to be transmitted is adjusted in accordance with the screen format of the virtual portable terminal; an image forming step for forming an image to fit within the screen display of the portable terminal of the receiving party, a storing step for storing the image as a file designated by a URL, a transmitting step for transmitting the file to the portable terminal; and a file forming step for forming a file designated by a URL with the file including the image and information capable of magnifying or reducing the image to fit within the screen display of the portable terminal of the receiving party.

According to another embodiment of the image processing method of the present invention, a URL is transmitted to a subscriber that created the image as well as transmitted to the address specified by the subscriber in the transmitting step.

The method further includes a storage step of storing the same image as the one transmitted to the portable terminal of the receiving party.

According to another embodiment of the present invention an image processing system includes an image processor having a receiver for receiving transmitter information, an address forming controller for appending the transmitter information and forming an address locating a storage location of an image, and an image processor transmitter for transmitting the image and the address, and a server for receiving the transmitted image and address, wherein said server has an address transmitter for transmitting the address to the portable terminal, and a storage for storing the transmitted image, wherein the portable terminal accesses the transmitted address and downloads the image corresponding to the transmitted address from the address transmitter to be a standby screen of the portable terminal.

According to another embodiment of the present invention, an image processing system includes a receiver for receiving processing directions of an image from a portable terminal of a receiving party to which the image is to be transmitted, an image processor controller for processing the image based on the processing directions, and an image transmitter for transmitting the processed image which has been processed by the image processor controller to the portable terminal of the receiving party.

The image processing system further includes an address transmitter for transmitting the address to a portable terminal, wherein the transmitter information is selected from the group consisting of an ID or a password for identifying the transmitter; an image processor for processing the image based on the processing directions; an image transmitter for transmitting the image processed by the image processor to the portable terminal of the receiving party; first storing device for storing the image and a second storing device for storing the image after processing.

According to one embodiment of the present invention, an image processor carries out a color variation process to change colors of the image or an adding process wherein additional data selected from the group consisting of characters, symbols or devices is added to the image.

The image processor includes an additional data selector for selecting additional data selected from the group consisting of arbitrary characters, symbols or devices each of a plurality of portable terminals, an image processor for making process images in which the additional data is added to an image, and an image transmitter for transmitting a processed image to each of a plurality of the portable terminals corresponding to the additional data.

According to another embodiment of the present invention, an image processing method includes an image processing directions receiving step of receiving processing directions of the image from a portable terminal to which the image is transmitted, an image processing step of processing the image based on the processing directions, and an image transmitting step of transmitting the processed image processed in the image processing step to the portable terminal of the receiving party.

According to another embodiment of the present invention, the image processing method further includes a first storing step for storing the image a second storing step for storing the image after being processed by the image processing step.

According to an embodiment of the present invention, a color variation process to change colors of the image or an adding process wherein data is selected from the group consisting of characters, symbols or devices is added to the image is carried out in the image processing step.

The method further includes an additional data selection step for selecting additional data selected from the group consisting of arbitrary characters, symbols or devices each of a plurality of portable terminals, an image processing step for making process images in which the additional data is added to an image, and an image transmitting step for transmitting a processed image to each of the plurality of the portable terminals corresponding to the additional data.

According to a further embodiment of the present invention, an image processing system includes a portable terminal to which an image is transmitted to a receiving party, a server coupled to the portable terminal through a communication channel and capable of transmitting stored images on receipt of directions from the portable terminal, wherein the server processes the image on receipt of the processing directions from the portable terminal and transmits the processed image to the portable terminal.

The server reads in and processes internally held images, holds the processed image, and transmits the processed image to the portable terminal.

The server also performs a color variation process to change colors of the image or an adding process in which data selected from the group consisting of characters, symbols or devices is added to the image.

According to a further embodiment of the present invention an image processing system includes a plurality of portable terminals to which an image is transmitted, a server connected with the plurality of portable terminals through a communication channel and capable of transmitting the image which is stored on receipt of the directions from the portable terminals, wherein the server selects additional data selected from the group consisting of arbitrary characters, symbols and devices each of the plurality of the portable terminals, makes processed images in which the additional data is added to the images, and transmits a processed image to each of the plurality of the portable terminals corresponding to the additional data.

According to another embodiment of the present invention, an information recording medium has a stored program including an image processing direction receiving step of receiving processing directions of an image from a portable terminal to which the image is transmitted, an image processing step for processing the image based on the processing directions, and an image transmitting step for transmitting the processed image processed in the image processing step to the portable terminal.

The information recording medium having the stored program further includes a second image holding process step of having the image held, wherein the image is read in and subjected to the processing in an image processing step, and the processed image is held at the storage location in the second image holding process step.

The information recording medium includes a color variation processing step to change colors of the image or an adding process for adding data of either characters, symbols or devices.

The information recording medium further includes an additional data selection step for selecting additional data of either arbitrary characters, symbols or devices for each of a plurality of portable terminals, an image processing step for making process images in which the additional data is added to an image, and an image transmitting step of transmitting the process images to the plurality of the portable terminals, respectively, corresponding to the additional data.

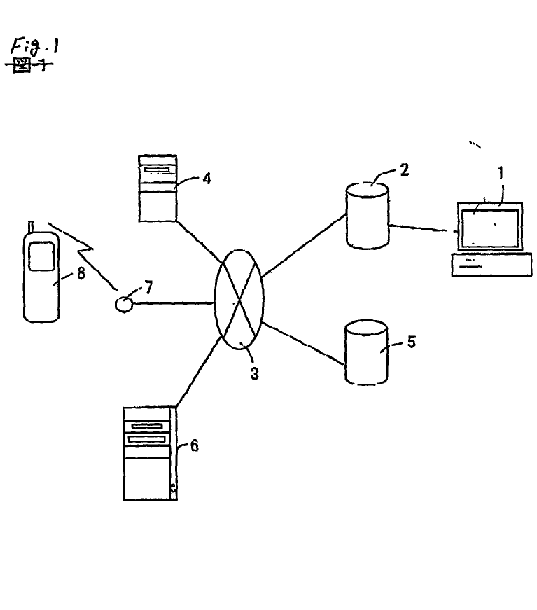

FIG. 1 shows a network system including a first embodiment of an image processor according to the present invention. The network system includes a user terminal 1, commercial provider servers 2 and 5, image providing server 4, portable terminal connecting server 6, communication station 7 and portable phone 8. Each of the devices communicates with or is coupled directly or indirectly to Internet 3. When a user transmits image data usable for a standby screen to another user, the user processes the image data at user terminal 1. The image data is processed at user terminal 1 so as to reformat it to fit in a screen display of portable phone 8 of a receiving party. The image data is also processed for data capacity, and data formatting of the image. Incidentally, if these parameters, the screen format, the data capacity and the data format of the image are uniformed in portable phone 8, the parameters which are not uniformed are set.

According to one embodiment of the present invention, processed image data and user information entered by the user are transmitted to image providing server 4, through commercial provider server 2 and the Internet 3. Commercial provider server 5 has a Web site for electronic settlement and is connected to the Internet 3. The user carries out user registration at the Web site of image providing server 4, followed by an image transmitting procedure.

The image data transmitted to image providing server 4 is stored in image providing server 4. Alternatively, image providing server 4 creates a Uniform Resource Locator (hereinafter, referred to as URL) identifying the storage location of the image, and appends the transmitted user information to an address in a predetermined format. Successively, image providing server 4 forwards the URL to portable phone 8 of a receiving party through the Internet 3, portable terminal connecting server 6 and communication station 7.

The receiving party having portable phone 8 specifies the forwarded URL. Then, the image data stored at the Web site identified by the URL is transmitted to portable phone 8 through the Internet 3, portable terminal connecting server 6 and communication station 7. Thus, the image data is presented as a standby screen of portable phone 8.

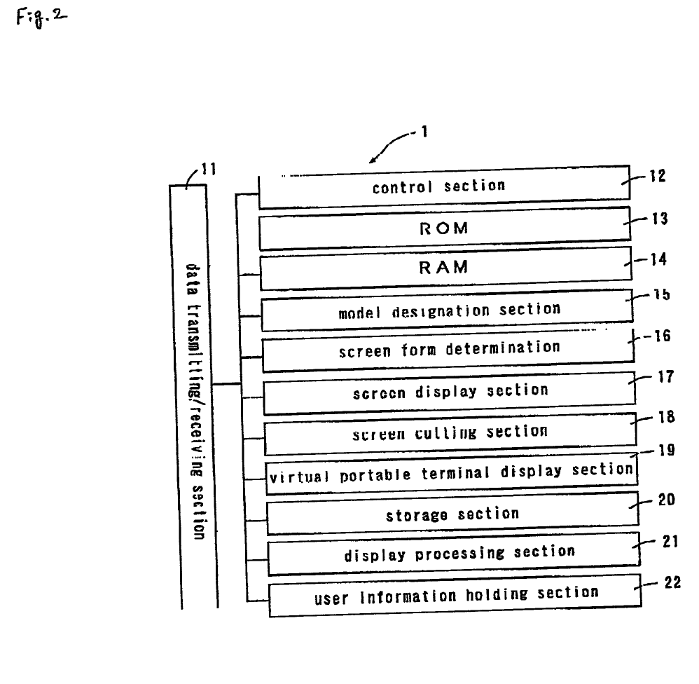

Each process in user terminal 1, image providing server 4 and commercial provider server 5 is explained in greater detail based on FIG. 2 to FIG. 13. FIG. 2 shows user terminal 1 which is an image processor. User terminal 1 includes a data transmitting/receiving section 11, a control section 12, a Read Only Memory (hereinafter, referred to as ROM) 13, a Random Access Memory (hereinafter, referred to as RAM) 14, a model designation section 15, a screen format determination section 16, a screen display section 17, a screen adjusting section 18, a virtual portable terminal display section 19, a storage section 20, a display processing section 21 and a user information holding section 22. Each of the above-mentioned sections may utilize processors and/or controllers to perform the recited functions.

Data transmitting/receiving section 11 transmits image data and user information to image providing server 4. Data transmitting/receiving section 11 may also receive an error notice, a notice on the completion of a transmission, and information to update a Web site from image providing server 4.

Control section 12 controls user terminal 1 and controls the processing action of model designation section 15. ROM 13 saves a control program of control section 12. Control section 12 controls each section based on the control program in ROM 13.

RAM 14 is a readable and writable memory where information such as model information for portable phones, image data of the portable phones (images of virtual portable terminals) and so on is stored. Accordingly, if a new model of a portable phone is on the market, information on the new portable phone such as the model name, screen format of the model, and the appearance of the portable phone can be added to RAM 14. Moreover, portable phone information of old models can be deleted from RAM 14.

Model designation section 15 receives input of each maker's portable phone model from the user. Screen format determination section 16 determines the screen format of the model, the data capacity, and the data format of the image. Screen display section 17 displays a screen of a virtual portable terminal to be displayed in accordance with the determined screen format.

Image adjusting section 18 adjusts an image for the standby screen of the receiving party's portable phone 8 from images of interest. Virtual portable terminal display section 19 displays an image of the virtual portable terminal which is the design of a portable phone on a screen display of image processor 1 when the user actuates the program.

Storage section 20 saves the image data transmitted by the user. Once storage section 10 reaches a predetermined capacity, previously saved data of images is deleted on a first in first out basis. Display processing section 21 displays a different frame when a corresponding button on the screen of the virtual portable terminal is actuated.

User information holding section 22 holds or stores user information specifically, an address of a receiving party and a password are held. When image data is transmitted, user information is read out from user information holding section 22 and transmitted together with the image data to image providing server 4.

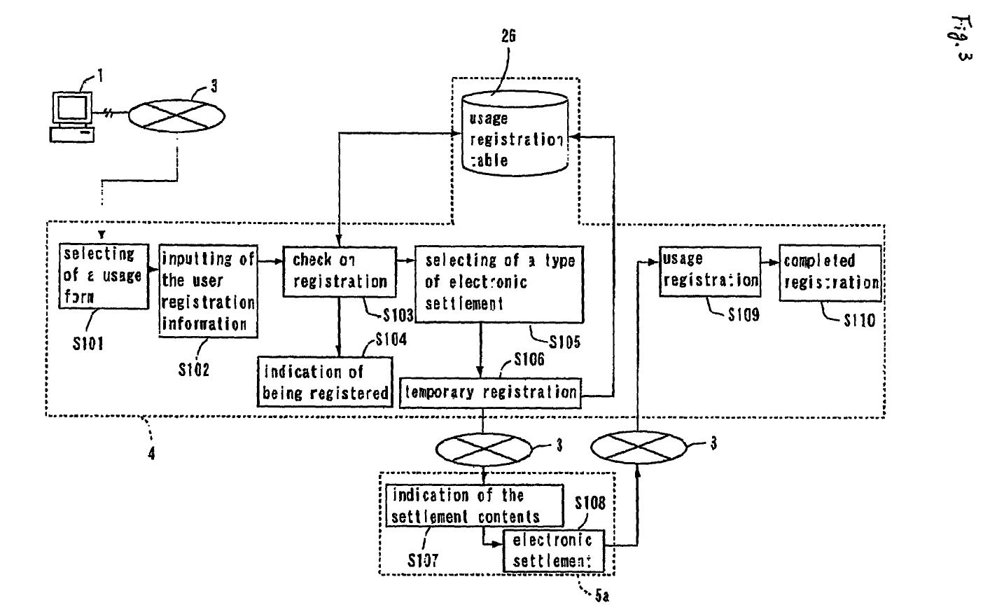

FIG. 3 shows a flow diagram for subscriber registration of an image providing service carried out by the user. The user carries out the subscriber registration as indicated below and then executes transmission of the image data. The user accesses the Web site for the subscriber registration stored at image providing server 4 from user terminal 1 through the Internet 3. After accessing the Web site for the subscriber registration, the user selects a usage form of the image providing service (step S101).

The usage form may be classified for example, into “all-day usage” in which the service is available for 24 hours and “monthly subscription” in which the service is continuously available any number of times. In the case of “all-day usage”, after the passage of 24 hours from the registration, the service is automatically canceled. On the other hand, in the case of the “monthly subscription”, the registration continues until a canceling procedure is carried out. A monthly fee is charged every month. Moreover, the “all-day usage” may be for 10-hours or 18-hour. Further, a “two-day usage” of 48-hour availability or a three-day usage of 72-hour availability may also be used.

After selecting the usage form, the user inputs user registration information (step S102). The user registration information may include user information such as, the mail address of a receiving party, the user's password, the user's name and contact information, etc.

After the user inputs user registration information, a verification is made (step S103). More specifically, the system verifies whether the combination of the email address and the password input by the user has already been registered or not. On the subscriber registration Web site, the system verifies the input information by communicating with usage registration table 26. Since the service is to transmit to one email address per one registration, the same email address having a different password is another registration.

According to one embodiment of the present invention, one image is assigned to one URL. Accordingly, if a user who has only one user registration, transmits a plurality of images to the same address, the new image is written over the old image data.

As a result of the verification process in step S103, when a user has already registered with the system, the system indicates that the user has already registered (step S104). More specifically, information is displayed to the user indicating registration has occurred as well as how long the transmitting service to the entered email address is available.

Alternatively, when the user is a new user and has never registered before, the new user proceeds to select a type of electronic settlement (step S105). In this step, a different type of settlement is adopted depending on the “all-day usage” or the “monthly subscription”. In the case of “all-day usage”, settlement is made by utilizing a Web site providing accounting services in a prepaid-card type or ID-password type format. On the other hand, in the case of the “monthly subscription”, settlement is made by utilizing a Web site providing accounting services in a ID-password type format.

After the user designates a settlement method, a temporary registration process is carried out (step S106). The temporary registration process may include, for example, issuance of a subscriber ID, registration of a mail address of a receiving party, password registration, usage form registration, settlement type registration, indication of temporary registration, etc. The result of the temporary registration process is stored at a usage registration table 26.

After the temporary registration process has been completed, indication of the settlement contents and the entry of an ID for settlement are carried out at an electronic settlement service providing Web site 5a connected to image providing server 4 through the Internet 3 (step S107). Afterwards, the electronic settlement process is performed (step S108).

Next, a formal usage registration process is carried out at image providing server 4 (step S109). In the formal usage registration process, indication of formal registration, valid term, settlement type, ID for settlement, etc. are stored in usage registration table 26. After the usage registration process has been completed, the entire registration process is complete (step S110).

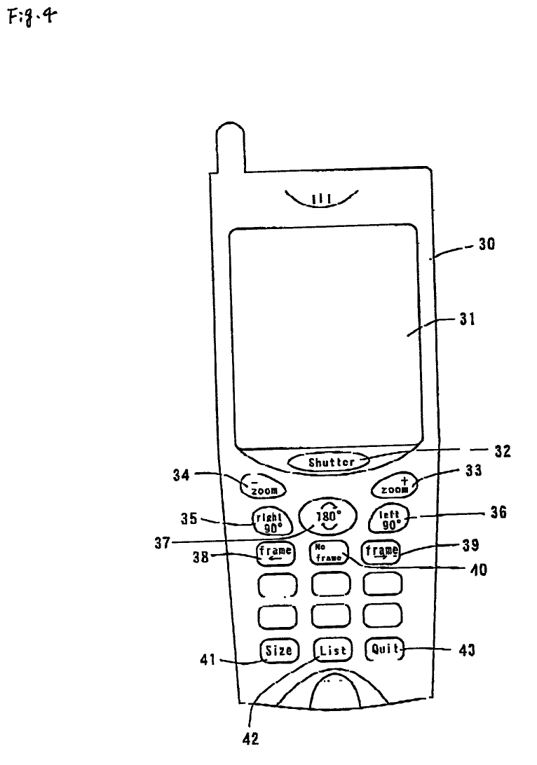

FIG. 4 shows a virtual portable terminal displayed when a program starts at a user terminal 1. A virtual portable terminal 30 which can be adjusted using a mouse connected to the user terminal 1. The virtual portable terminal display is movable upward, downward, to the right and to the left on the screen of the user terminal 1.

The virtual portable terminal 30 is provided with a display section 31, a shutter key 32, a zoom-up key 33, a zoom-out key 34, a 90° right turn key 35, a 90° left turn key 36, a 180° turn key 37, frame keys 38, 39, a non-frame key 40, a size key 41, a list key 42 and a quit key 43.

The display section 31 is a window for cutting out an image or a portion of the image. The display section 31 changes in size and shape by the user's setting model on his portable phone. This mechanism will be described later.

The shutter key 32 reads in an image after the position of the image is specified at the display section 31. The zoom-up key 33 magnifies the image displayed on the display section 31. The zoom-out key 34 reduces the image displayed on the display section 31.

The 90° right turn key 35 turns the image displayed on the display section 31 to the right (that is clockwise) by 90° before pressing the shutter key 32. The 90° left turn key 36 turns the image displayed on the display section 31 to the left (that is counterclockwise) by 90° before pressing the shutter key 32. The 180° turn key 37 turns the image surrounded at the display section 31 by 180° to be up side down before pressing the shutter key 32.

The frame keys 38, 39 apply a design around the image displayed on the display section 31 before pressing the shutter key 32. The frame key 38 and the frame key 39 output data of different designs, respectively. Moreover, non-frame key 40 is pressed when the design applied around the image is not necessary. In particular, non-frame key 40 is pressed in order to delete a design which was set in a previous input when images are input consecutively.

The size key 41 sets the model of the portable phone, the size and the coloration of the image. The list key 42 views the past image data. The quit key 43 stops the image from being transmitted. Incidentally, the above keys can be turned on using the mouse. Alternatively, the keys can be turned on using a keyboard.

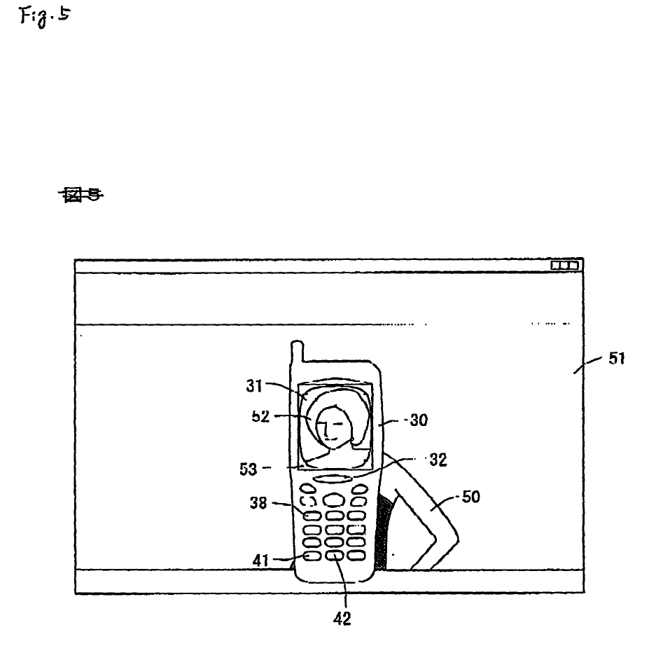

FIG. 5 shows the image inputting work with the virtual portable terminal shown in FIG. 4. As shown in FIG. 5, the user moves the virtual portable terminal 30 over an image 51. The image 51 may include a character image 50. The user then sets a transmitting image 52 desired to input in the display section 31. Afterwards, the user activates frame key 38 and a design 53 is displayed around the transmitting image 52. The shutter key is pressed in such a state, and then the image applied with the design 53 is input in the transmitting image 52 displayed on the display section 31.

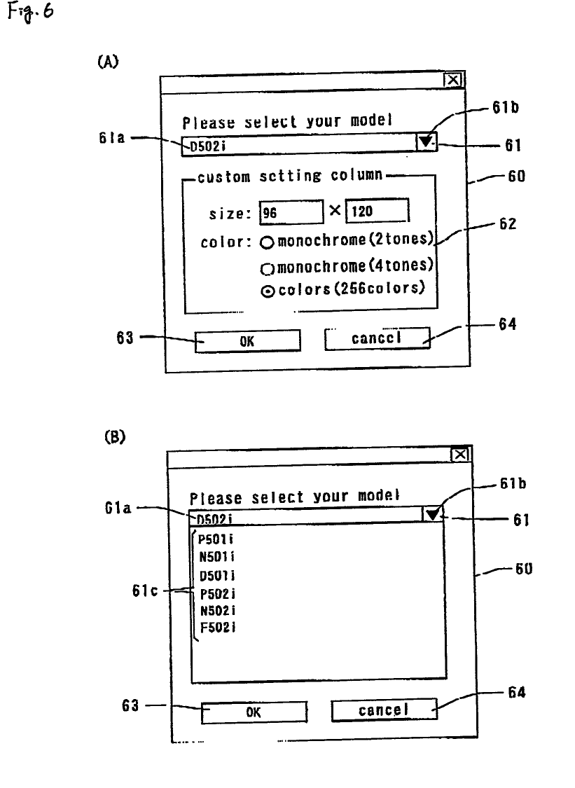

In FIG. 5, a form of the display section 31 can be set with the size key 41. FIG. 6(A) shows a terminal setting screen displayed when the size key 41 is pressed. The terminal setting screen 60 is provided with a model selection column 61 for selecting the model of the portable terminal, a custom setting column 62 for setting the image size and the coloration, a setting confirmation key 63 and a set cancel key 64.

The user can input the length and the width of the image at the custom setting column 62. Moreover, the user can select either monochrome (two tones), monochrome (four tones), or colors (256 colors). In the model selection column 61 in FIG. 6(A), there is displayed a model 61a which has been set when the previous image is input. In order to alter the model 61a, a reversed triangle part 61b at the right hand of the model selection column 61 is pressed.

Then, as shown in FIG. 6(B), a list of models 61c is displayed downward in the model selection column 61. The user can select the model which the receiving party has from the list of models 61c. When the model is selected by the user, the model selected is displayed in the model selection column 61, and the numbers of the size are automatically altered. If the automatically altered numbers need to be changed, the user can manually change the sizes. Incidentally, the data capacity and the image data format which are different depending on the portable phone 8, are set by selecting the model, although they are not shown on the screen of the user terminal 1.

Thus, the user sets the image size by setting the portable phone model of the receiving party, and after setting the image coloration, the setting confirmation key 63 is pressed. And then, the display section 31 of the previously shown virtual portable terminal 30 changes to the current size and shape. Moreover, the coloration of the transmitting image 52 also changes.

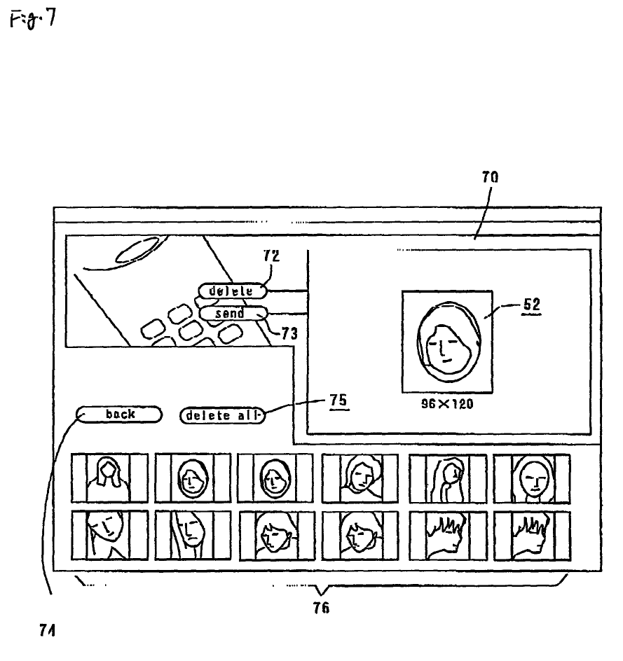

FIG. 7 shows a list screen displayed when the list key 42 is pressed after the transmitting image 52 has been entered. On the list screen 70, the transmitting image 52 and past images 76 are displayed. The user can confirm the transmitting image 52 and the past images 76 on the list screen 72 being displayed and transmit these images to the receiving party. Therefore, the possibility of mistakenly transmitting the same image as the past images 76 is low.

Moreover, as shown in FIG. 7, list screen 70 is provided with a delete key 72, a send confirmation key 73, a back key 74, and a delete all key 75. The delete key 72 deletes the transmitting image 52 which has been input. The send confirmation key 73 transfers the transmitting image 52 to a transmitting confirmation screen prior to transmitting. The back key 74 goes back to the screen where the virtual portable terminal 30 is displayed. The delete all key 75 deletes all the past images 76.

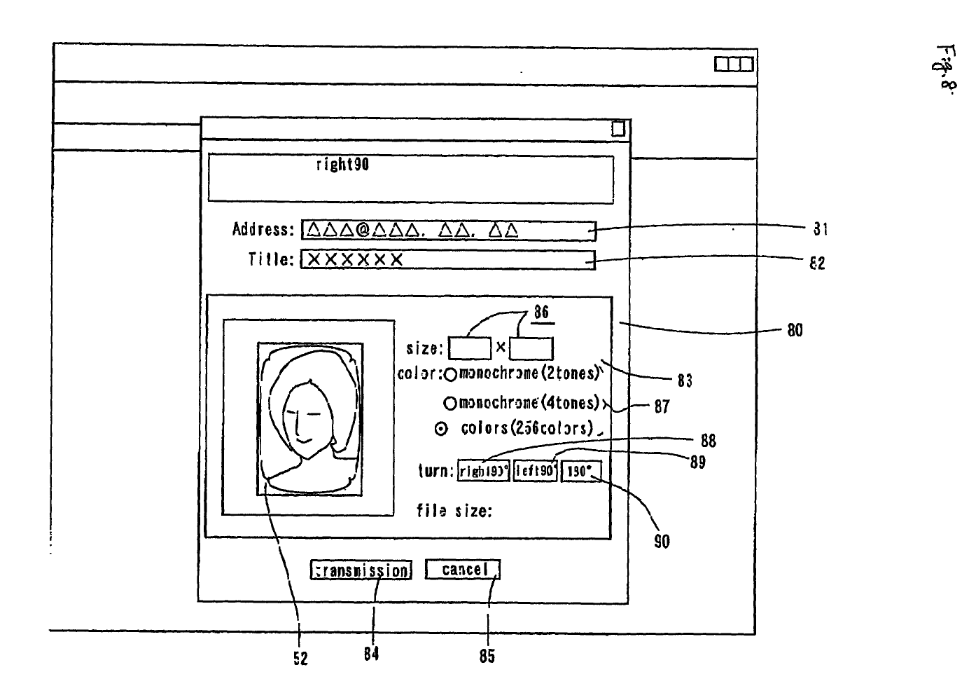

FIG. 8 shows a transmitting confirmation screen 80 displayed when the send confirmation key 73 is pressed on the list screen 70 shown in FIG. 7. The transmitting confirmation screen 80 is provided with an address of the receiving party entry column 81, a title entry column 82, and an image processing column 83 including the transmitting image 52, a transmission key 84, and a cancel key 85. Moreover, the image processing column 83 is provided with a size entry column 86 and a coloration designation column 87 which are same as those of the custom setting column 62 shown in FIG. 6. Moreover, the image processing column 83 is provided with a 90° right turn key 88, a 90° left turn key 89 and a 180° turn key 90.

The user enters the address of the receiving party in the column 81 before transmitting the transmitting image 52. Moreover, the user can enter a mail title for transmitting the transmitting image 52 at the title entry column 82. Incidentally, the title may be either a requisite entry matter or an optional entry matter.

The user confirms the contents of the size entry column 86 and the coloration designation column 87, and when the user desires to specify different contents, alternations may be made in the size entry column 86 and the coloration designation column 87. Further, the user can turn the transmitting image 52 by pressing the 90° right turn key 88, the 90° left turn key 89 or the 180° turn key 90.

The user presses the transmission key 84 after the predetermined process of the transmitting image 53 has been completed. And then, data of the transmitting image 52, the title, the user information and so on is transmitted to the image providing server 4. When the transmitting image 52 is transmitted, the same image data is stored and added to the past images 76. Incidentally, in order to cancel the transmission, the transmission is stopped by pressing the cancel key 85.

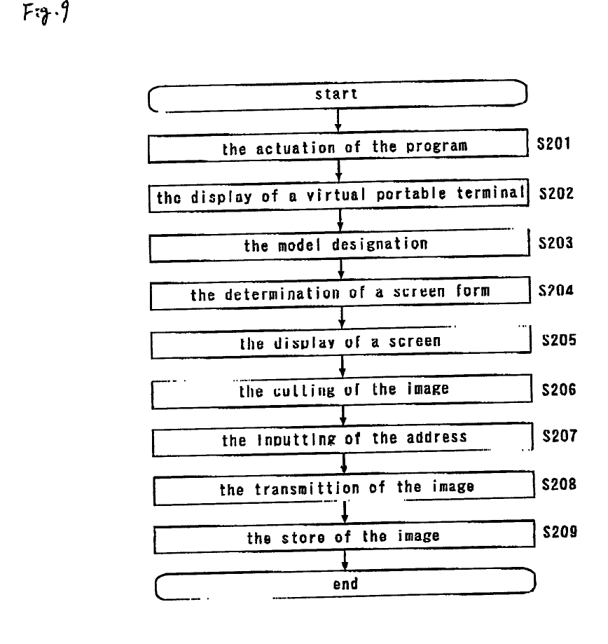

Next, a flow of the image processing and the transmitting process at the user terminal 1 is explained based on the flowchart of FIG. 9. First, the user actuates the program in the user terminal 1 (step S201). When the program is actuated, the virtual portable terminal display section 19 displays a virtual portable terminal on the screen of the user terminal 1 (step S202). Next, the user enters the portable phone model and a model designation section 15 designates the entered model (step S203).

Afterwards a screen format determination section 16 determines the screen format of the designated model (step S204). Next, a screen display section 17 displays the screen of the virtual portable terminal in accordance with the determined screen format (step S205). Next, an image adjusting section 18 adjusts out the image within the display section 31 on receipt of an on-signal of the shutter key 32 (step S206).

Next, a control section 12 receives entry of the address of the receiving party from the user (step S207). A data transmitting/receiving section 11 transmits the image to the entered address (step S208). Subsequently, a storage section 20 stores a copy of the transmitted image (step S209). Incidentally, the copy of the image may be transmitted and the storage section 20 may store the image also.

Moreover, a program including a transmitting step, a model designation step, a screen format determination step, a screen display step, an image adjusting step, a virtual portable terminal display step and a storage step executing the same processing actions as those of the data transmitting/receiving section 11, the model designation section 15, the screen format determination section 16, the screen display section 17, the screen adjusting section 18, the virtual portable terminal display section 19 and the storage section 20 which are provided to the user terminal 1, respectively, may be incorporated. The above program may be stored in an information recording medium such as a floppy disk and a CD-ROM to be marketed.

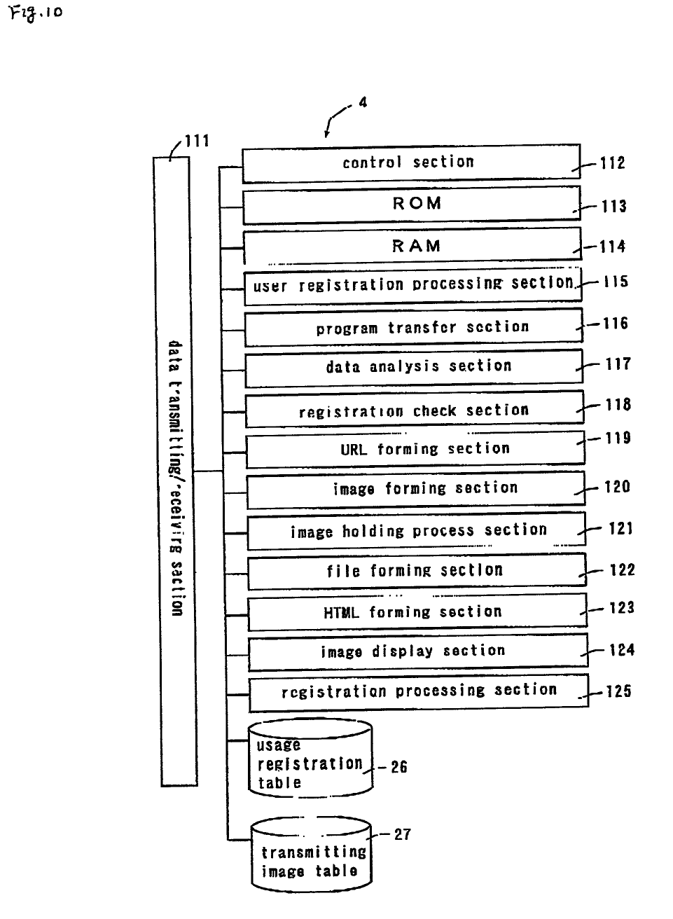

The image providing server 4 which is an image processor serving as a server will be explained in greater detail based on FIG. 10. The image providing server 4 (image processor) includes a data transmitting/receiving section 111, a control section 112, a Read Only Memory (hereinafter, referred to as ROM) 113, a Random Access Memory (hereinafter, referred to as RAM) 114, a user registration processing section 115, a program transfer section 116, a data analysis section 117, a registration check section 118, a URL forming section 119, an image forming section 120, an image holding process section 121, a file forming section 122, an HTML forming section 123, an image display section 124, a registration processing section 125, a usage registration table 26, and a transmitting image table 27. The data transmitting/receiving section 111 sends various notices to the user terminal 1 and serves both as a transmitting means to transmit image data and a formed URL and to a portable phone 8 of the receiving party and a transmitter's information receiving means to receive the transmitter's information. Moreover, the data transmitting/receiving section 111 receives the image data and mail from the user terminal 1.

The control section 112 controls the entire image providing server 4. The ROM 113 stores a control program of the control section 112. The RAM 114 is a readable and writable memory where data such as the user's application and a program for image magnification/reduction is stored.

The user registration processing section 115 processes registration matters from the user and user registration is carried out. The program transfer section 116 performs a process of transferring mail data transmitted from the user to the program. The data analysis section 117 analysis a transmitter, a receiving party or the like, a time period check, a version check of application software, as well as the mail data.

The registration check section 118 determines the registration state of the user. The URL forming section 119 is an address forming means for appending a subscriber's ID, encrypted password, and distribution ID to an address in predetermined format and forming a URL as an image data storage location. The image forming section 120 forms an image in accordance with the display form of the portable phone to which the image is transmitted. Image forming section 120 also processes image data when an arbitrary form of the image is transmitted from the user terminal 1. The image holding process section 121 holds the image data, magnifies/reduces information, and provides an image title, etc. The file forming section 122 forms a file in which the magnified/reduced information is stored together with the image data. Moreover, the image holding process section 121 also stores the image data in the transmitting image table 27.

The HTML forming section 123 forms HTML necessary for displaying image data. Image display section 124 displays the image at a browser. The registration processing section 125 allows the user to carry out procedures for password alternation or canceling the subscription. The usage registration table 26 stores the user's registration information. Moreover, the transmitting image table 27 is a storage means to store the image data to be transmitted to the portable phone 8 of the receiving party. In addition to the image data, additional information such as the magnification/reduction information, the image title and so on may be stored therein.

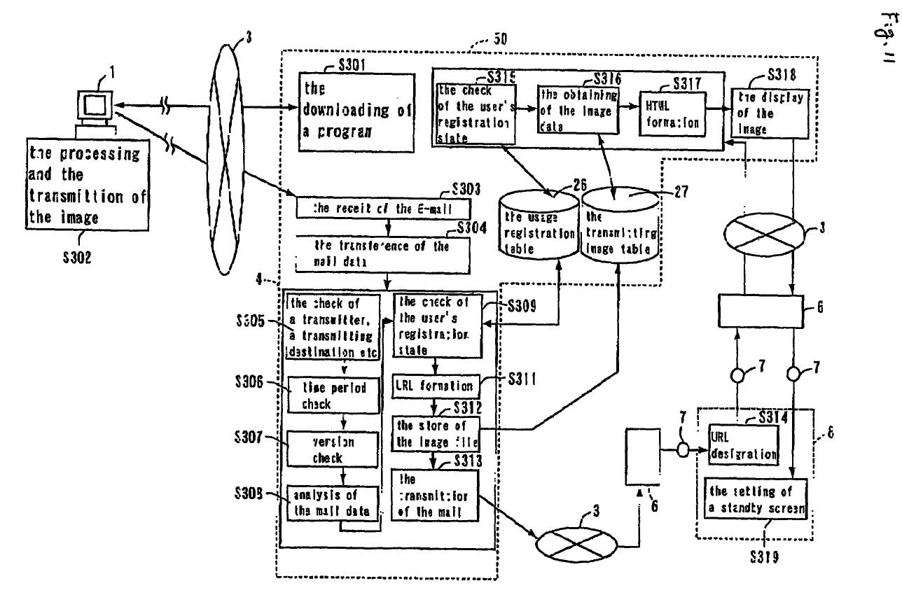

Next, a flow of processes from the image processing process and transmission at the user terminal 1 to the image being transmitted to the receiving party's portable phone 8 will be explained based on FIG. 11. First, the user downloads a predetermined program through the Internet 3 from a program downloading site of the image providing server 4 (step S301). After the program has been downloaded, the user terminal 1 becomes an image processor. The user processes and transmits the image as shown in FIG. 9 (step S302). Mail including image data transmitted from the user terminal 1 and the user's information in text format is received at the image providing server 4 through the Internet 3 (step S303). Next, the mail data is transferred to a program for image transmission (step S304).

Next, the program for image transmission checks on a transmitter, a receiving party and a subject (step S305). Then, a time period check is carried out (step S306). That is because it cannot be proceeded when transmitted during a holding time period.

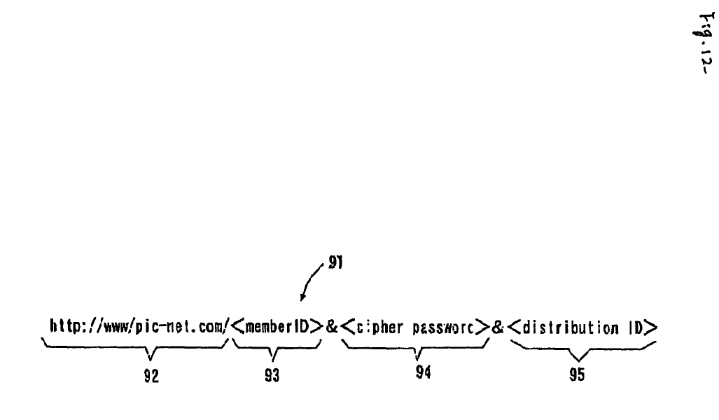

Next, a version check is carried out (step S307). This is because the process differs depending on a version of the program downloaded by the user. Afterwards, an analysis of the mail data is executed (step S308). More specifically, an analysis of text data and acquisition of the image data are carried out. Next, a check is performed regarding the user's registration state, that is the email address of the receiving party, valid term whether the user's registration has expired or not and so on (step S309). More specifically, the image providing server 4 searches the usage registration table 26 and checks whether the transmitter and the email address of the receiving party are registered or not. If they are not registered, an error occurs. In such a case, the image data is abandoned. A message data indicating that an error has occurred and suggests registering the receiving party is transmitted to the transmitter's address. Moreover, if the receiving party is registered, a URL identifying a Web site where the transmitting image 52 is stored is formed (step S311). In step S311, the address forming means of the image providing server 4 forms a URL 91 as shown in FIG. 12. The URL 91 is formed by appending the transmitter's subscriber ID 93, encrypted password 94 and distribution ID 95 to a URL 92 in predetermined format. With the URL 92 in this predetermined format, others possibly entering the URL at random or entering it by a glance is reduced.

However, since the subscriber ID 93, the encrypted password 94 and the distribution ID 95 are appended, the possibility of others entering the URL at random and stealing the image becomes extremely low. In particular, with the encrypted password 94, an unauthorized person that steals a glance at the portable phone 8 cannot learn the URL 91. Moreover, variations of an image are stored in unique image IDS, therefore, even if the encrypted password 94 is learned, it is not possible to steal an image and the plurality of variations of that image. Thus, the damage is to be minimized. On the other hand, the owner of the portable phone 8 only needs to designate the transmitted URL 91 and does not have the burden of unnecessarily entering the image data. But, only one of the subscriber ID 93, the encrypted password 94, and the distribution/image ID may be appended. In an alternative embodiment instead of the encrypted password 94, a password which is not encoded may be employed by displaying a part for the password with an asterisks on the screen of the portable phone 8.

When the URL 91 is formed in step S311, the image transmitting means transmits and saves the image data to a storage location of the URL 91 (step S312). More specifically, the image data is transmitted and stored to the transmitting image table 27. On the other hand, the address transmitting means transmits the URL formed in step S311 to the portable phone 8 of the receiving party (step S313). Next, the receiving party designates the URL 91 (step S314). The designation reaches the image providing server 4 through a communication station 7, the portable terminal connecting server 6 and the Internet 3. Then, a check on the registration state is carried out at the image providing server 4 (step S315). More specifically, the check is carried out by accessing the usage registration table 26 on whether it is the URL 91 including the registered address or not.

As a result of the registration state check, in a case where it is not registered, an error indication is made at the portable phone 8, while in a case where it is registered, the image data is obtained from the transmitting image table 27 (step S316). Subsequently, an HTML is formed (step S317). The image data is displayed (step S318). The image data is transmitted to the portable phone 8 for display on its standby screen (step S319). Incidentally, the address forming means and the address transmitting means may be provided to the user terminal 1 instead of being provided to the image providing server 4. In such a case, a transmitter's information receiving means which is provided to the user terminal 1 receives the subscriber ID and the password entered by the user and then they are appended to a predetermined address so as to form the URL 91 as shown in FIG. 12.

In this way, it is not necessary to provide the address forming means to the image providing server 4. But, when the data amount in the user terminal 1 needs to be as small as possible, as explained in FIG. 11, the address forming means is desirably provided to the image providing server 4.

The image displayed at the URL 91 can be viewed only from a specific portable phone 8. The image providing server 4 maintains the portable phone's peculiar IDs. The image providing server 4 when accessed for viewing an image from the portable phone 8, compares the portable phone peculiar IDs which are maintained and the ID of the accessing portable phone, and only when they match the image is displayed. When the image providing server 4 does not maintain the portable phone's peculiar IDs, or when the ID of the accessing portable phone does not match, the image can be displayed by entering the password which has been set in usage registration by the portable phone 8. In a case where the image is displayed with the password, the ID of the accessing portable phone is saved in the image providing server 4. A receiving party can changes his portable phone by sending a request the form of an email instructing the server to change his phone. Alternative, the receiving party can email the server user the new portable phone and the server will know that the receiving party has a new telephone number.

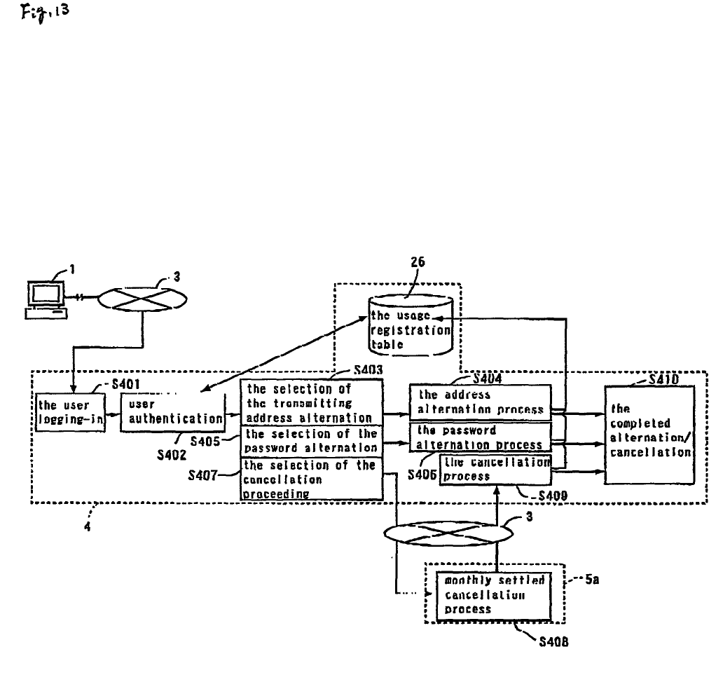

Next, a flow of proceedings of the subscriber's data alternation and cancellation carried out by a monthly subscription user will be explained based on FIG. 13. The user logs onto an exclusive Web site for subscribers on the image providing server 4 from the user terminal 1 (step S401). In step S401, logging-in is made possible by the user entering a mail address of a receiving party and password. Next, user authentication is carried out at the exclusive Web site for the subscribers (step S402). More specifically, registration data from the usage registration table 26 is searched. If the user is not registered, an error indication is transmitted to the user's terminal 1. If the user is registered, an exclusive Web page is displayed to the subscriber. When the user selects transmitting address alternation on the exclusive Web page for (step S403) the address alternation process is carried out (step S404). Moreover, when the user selects password alternation on the exclusive Web page (step S405), the password alternation process is carried out (step S406).

On the other hand, when the user selects cancellation proceeding on the exclusive Web page (step S407), a monthly settlement cancellation process is carried out at an electronic settlement service providing site 5a at a commercial provider server 5 (step S408). Subsequently, the cancellation process is carried out at the exclusive Web page (step S409). Following step S404, step S406 or step S409, a storage or delete process of registration data in the usage registration table 26 is performed so that the process of alternation/cancellation is complete (step S410).

The image processor, the image processing method, the image processing system and the information recording medium according to the present invention are not limited to the above-mentioned embodiment, and various modifications may be made without departing from the spirit and scope of the present invention. For example, at least one of the virtual portable terminal display section 19 and the storage section 20 may not be provided at the user terminal 1. In a case where the virtual portable terminal display section 19 is not provided, an image is adjust in a screen format based on the model designated at the model designation section 15 without a portable phone being displayed. Even in such an alternative manner, the image in accordance with the screen display of the portable phone 8 of the receiving party is set.

However, when the image is adjusted in a state where the virtual portable terminal is displayed, it is possible for a transmitter to transmit the image after confirming how it is set on the receiving party's portable phone 8. Accordingly, it is preferable to provide the virtual portable terminal display section 19.

Moreover, in a case where the storage section 20 is not provided, the transmitted image is not saved in the user terminal 1; however, in a case of frequently transmitting images to the same destination and so on, it is better that the transmitter grasps whether the image has been already transmitted or not. Accordingly, it is preferable to provide the storage section 20.

Moreover, the virtual portable terminal display step may display the entered model of the portable phone after entering the model because of the above reasons. Incidentally, it may be an information recording medium having a stored program including a transmitting step, a model designation step, a screen format determination step, a screen display step and an image adjusting step and not including at least one step of a virtual portable terminal display step and a storage step.

Moreover, instead of the display of the virtual portable terminal, an image of another image reading apparatus such as a camera may be displayed so that the transmitting image 52 is cut by the tripping action of the shutter. Moreover, without the storage section 20 being provided at the user terminal 1, a storage means may be located in a remote area through the Internet 3. In such a case, the transmitted image is stored in a storage section at the remote area.

Moreover, in the above mentioned embodiment, the user terminal 1 transmits a URL 91 to the portable phone 8 of the receiving party and transmits the image data to the transmitting image table 27; however, instead of transmitting the URL 91, the image data may be directly transmitted to the portable phone 8.

Moreover, the program downloaded by the user may be free or may not be free. New image data may be included in the program downloaded by the user. In such a case, it is not necessary for the user to input image data from a different homepage with image processor 1 or have photographs scanned in with a scanner.

Another embodiment of the image processor, the image processing method, the image processing system and the information recording medium according to the present invention will be explained based on the drawings. In this embodiment, an example with a portable phone as a portable terminal of a receiving party will be described, but the portable terminal may be a small communication terminal such as a mobile computer.

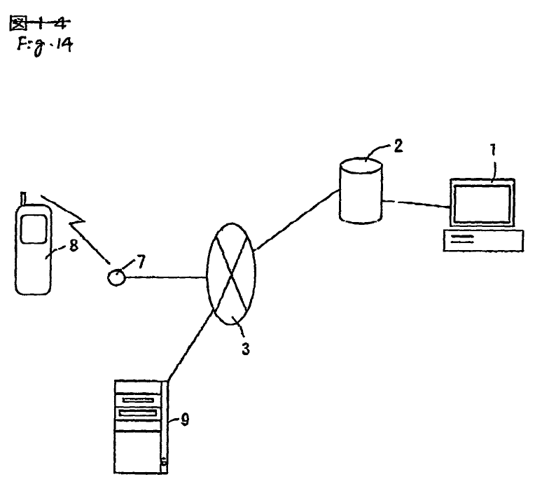

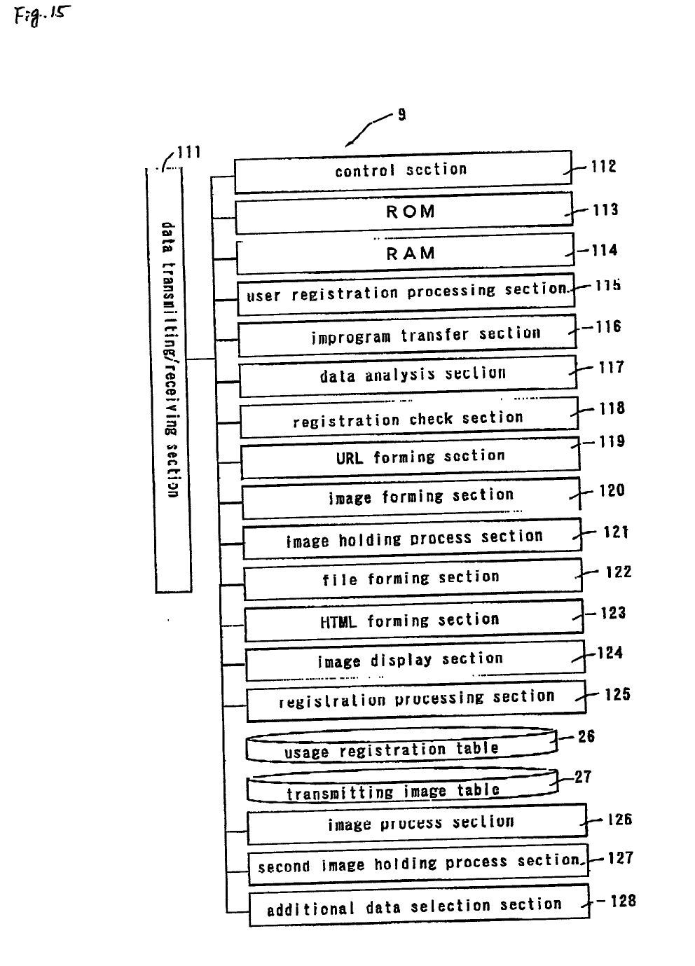

According to an embodiment invention an image processing system includes a user terminal 1, a commercial provider server 2, Internet 3, a communication station 7, a portable phone 8 and a server 9 which is a image processor as shown in FIG. 14. When the user transmits image data which can be used for a standby screen to a receiving party or the user oneself (hereinafter, an example of the other user will be explained), the image data is processed by image processor 1 of the user. The image data is processed so as to correspond to the screen format of the portable phone 8 as a portable terminal of the receiving party, the data capacity and the image data format. If some of the parameters of the screen format, the data capacity, the image data format are uniformed with the portable phone 8, the items which are not uniformed may be set.

Thus, processed image data and user information entered by the user are transmitted to the server 9 through the commercial provider server 2 and the Internet 3. Incidentally, the user carries out user registration at a Web site for user registration provided by server 9 followed by an image transmitting procedure.

The image data transmitted by the user is saved once on server 9. On the other hand, server 9 may append user's information to an address in a predetermined format and creates a URL which locates a storage location of the image data. Subsequently, the server 9 forwards the URL to the portable phone 8 of the receiving party through the Internet 3 and the communication station 7.

When the receiving party of the portable phone 8 designates the forwarded URL from server 9, the image data stored at the location located by the URL is transmitted to the portable phone 8 through the Internet 3, the portable terminal connecting server 6 and the communication station 7. Thus, the image data is presented on the standby screen of the receiving party's portable phone 8.

Server 9 is a server connected with the portable phone 8 through the Internet 3 and capable of transmitting the stored image (the original image) on receipt of directions from the portable phone 8. Moreover, the server 9 processes the original image on receipt of the directions to process the original image from the portable phone 8, and holds and transmits the processed image (process image) to the portable phone 8. According to one embodiment of the present invention, the image data may be transmitted to the portable phone 8 without once holding the processed image.

The server 9 is capable of carrying out a color variation process to change colors of the original image or an adding process to add additional data of either characters, symbols or devices to the original image. The detail thereof will be described later.

Moreover, the server 9 is capable of transmitting one image to a plurality of portable phones 8. The server 9 selects additional data of either arbitrary characters, symbols, or devices and makes process images in which each additional data is added to the original image. Thereafter, the server 9 transmits the processed image to each of the portable phone 8 corresponding to the additional data. Thus, the server 9 not only holds and transmits the original image but also serves as an image processor to process images based on the directions from the portable phone 8. Moreover, the server 9 transmits even different images to portable phones 8, respectively instead of transmitting the same image to a plurality of the portable phones 8. Therefore, the server 9 in this embodiment of the image processing system performs the functions of the image providing server 4 illustrated in the first embodiment, the portable terminal connecting server 6 and the user terminal 1.

Server 9 will be described, in greater detail below in FIGS. 2 and 10. Server 9 includes a data transmitting/receiving section 111, a control section 112, a Read Only Memory (hereinafter, referred to as ROM) 113, a Random Access Memory (hereinafter referred to as RAM) 114, a user registration process section 115, a program transfer section 116, a data analysis section 117, a registration check section 118, a URL forming section 119, an image forming section 120, an image holding process section 121, a file forming section 122, an HTML forming section 123, an image display section 124, a registration process section 125, a usage registration table 26, a transmitting image table 27, an image process section 126, a second image holding process section 127 and an additional data selection section 128.

The data transmitting/receiving section 111, the control section 112, the ROM 113, the RAM 114, the program transfer section 116, the data analysis section 117, the URL forming section 119, the image forming section 120, the image holding process section 121, the file forming section 122, the HTML forming section 123, the image display section 124, the registration process section 125, the usage registration table 26 and the transmitting image table 27 perform the same functions as described in FIG. 10.

However, the data transmitting/receiving section 111 includes both an image process direction receiver to receive directions to process an image from the portable phone 8 and an image transmitter to transmit the processed image which has been processed to the portable phone 8. The data transmitting/receiving section 111 is capable of transmitting the processed images which have different additional data added depending on each portable phone 8. Moreover, the data transmitting/receiving section 111 also receives the image data from the user terminal 1 and the user's data entered through the Web site.

The image process section 126 provides a color variation process to change colors of the original image or an addition process to add additional data of either characters, symbols or devices to the original image based on process directions from a portable phone 8. The image process section 126 is capable of, for example, changing the background of the original image or appending an arbitrary string of characters generated by a random number to the original image.

The second image holding process section 127 processes the original image and the processed images held in the transmitting image table 27. Moreover, the transmitting image table 27 is an image holding means to hold not only the original image transmitted from the user terminal 1 but also the processed images having been subject to processing based on the directions of the portable phone 8. The additional data selection section 128 selects additional data such as characters, symbols or devices.

The user registration process section 115 temporarily registers a beginning user as well as carries out formal registration followed by the temporary registration. The registration check section 118 checks whether the user has been temporally registered or not, or formally registered or not.

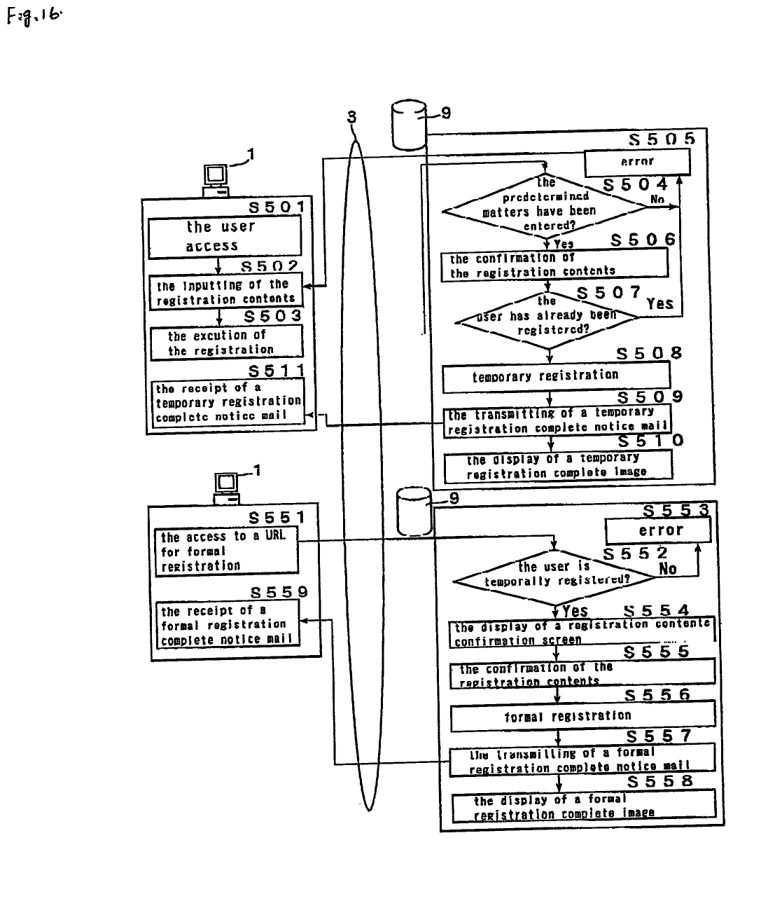

Next, a flow of data processing among the user terminal 1, the portable phone 8 and the server 9 will be explained. FIG. 16 is a diagram illustrating the flow of the registration process for registering the user. First, the user accesses a Web site provided by the server 9 with the user terminal 1 (step S501). Next, the user enters registration contents in a predetermined page of the Web site (step S502) and transmits a signal to execute the registration to the server 9 (step S503). The server 9 having received the signal to execute registration determines whether predetermined matters which are necessary for the temporary registration of the user have been entered (step S504). As a result, in a case where all the predetermined matters has not been entered, the user registration process section 115 of the server 9 creates an error indication (step S 505) and the error indication is displayed to the user terminal 1. The registration entry screen also returns.

On the other hand, in a case where all of the entries have been made, the server 9 recommends confirming the registration contents (step S506) and determines whether the user has already been temporarily registered or not (step S507). As a result, when the user has been temporarily registered, the process goes to step S505. On the other hand, when the user has not been registered, the server 9 carries out temporary registration (step S508). Next, the server 9 transmits a temporary registration complete notice mail to user terminal 1 (step S509), while user terminal 1 receives the temporary registration complete notice transmitted in S509 (step S511). Thus, the user's temporary registration is completed.

Next, a process in which the temporarily registered user carries out formal registration will be explained. A URL for formal registration (official registration) is indicated on the temporary registration complete notice received in step S511. Thus, the user seeking formal registration accesses a Web page of the indicated URL in the temporary registration complete notice mail (step S551). Server 9 then determines whether the user having accessed is temporarily registered or not (step S552). As a result, when the user has not been registered, server 9 indicates an error (step S553).

On the other hand, when the user has been temporarily registered, the server displays a registration contents confirmation screen at user terminal 1 (step S554). Server 9 confirms the registration contents (step S555) and carries out formal registration (step S556). Next, server 9 transmits a formal registration complete notice mail to user terminal 1 (step S557). Server 9 displays a formal registration completion screen (step S558), while user terminal 1 receives the formal registration complete notice mail transmitted in S557 (step S559). Thus, the user's formal registration process is completed.

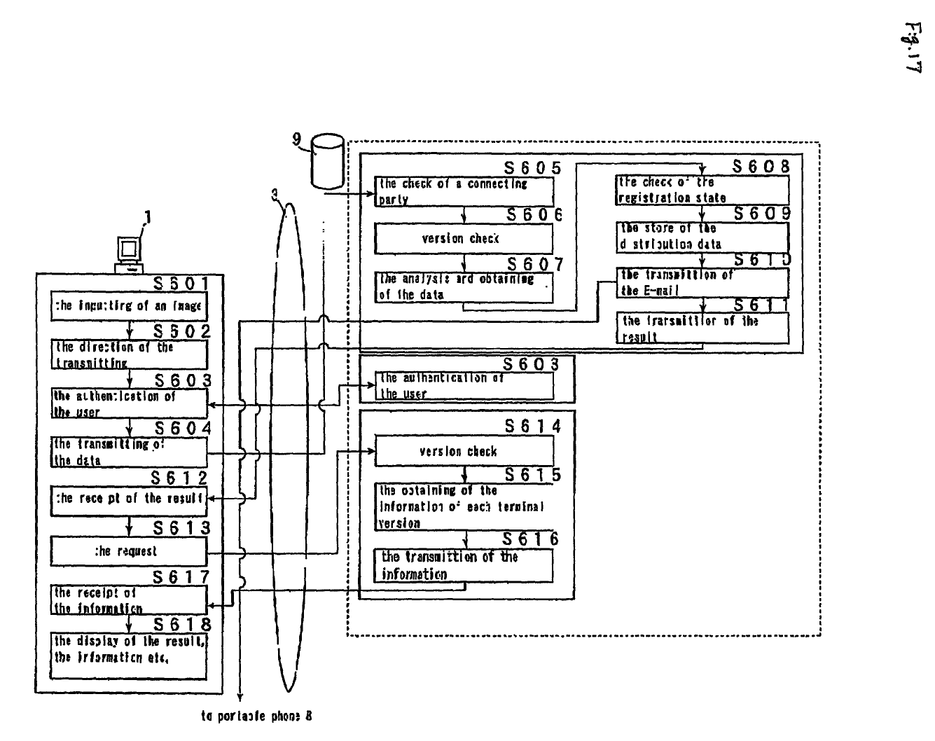

FIG. 17 is a flow diagram illustrating the process in which the server 9 receives data of an image (the original image) from user terminal 1. The user inputs an image at user terminal 1 (step S601) and gives directions to transmit the data to server 9 (step S602). Then, authentication of the user is carried out between the server 9 and the user terminal 1 (step S603). Next, the user terminal 1 transmits the receiving party's information and the data of the original image to the server 9 (step S604). The server 9 checks on a connecting party (step S605), performs a version check of the terminal (step S606), and analyzes and obtains the receiving party's information and the data of the original image which have been transmitted (step S607). Next, the server 9 checks on the receiving party's registration state (step S608), and saves the distribution data (the original image data) (step S609).

Next, the server 9 sends an electronic mail in which a URL is sent to the receiving party (step S610). Moreover, the server 9 transmits a notification to the user, indicating that data of the original image has been transmitted to the receiving party (step S611). The user receives the above mentioned notice notification at the user terminal 1 (step S612). Next, when the user requests server 9 for information of each terminal version or data of advertisement (step S613), the server 9 checks on the terminal version (step S614), and obtains the information of each terminal version and the data of advertisement (step S615). Server 9 transmits the information of each version or the data of advertisement to user terminal 1 (step S616). User terminal 1 receives the above mentioned data transmitted by server 9 (step S617) and displays the same (step S 618). Incidentally, steps from step S613 to step S618 may be omitted.

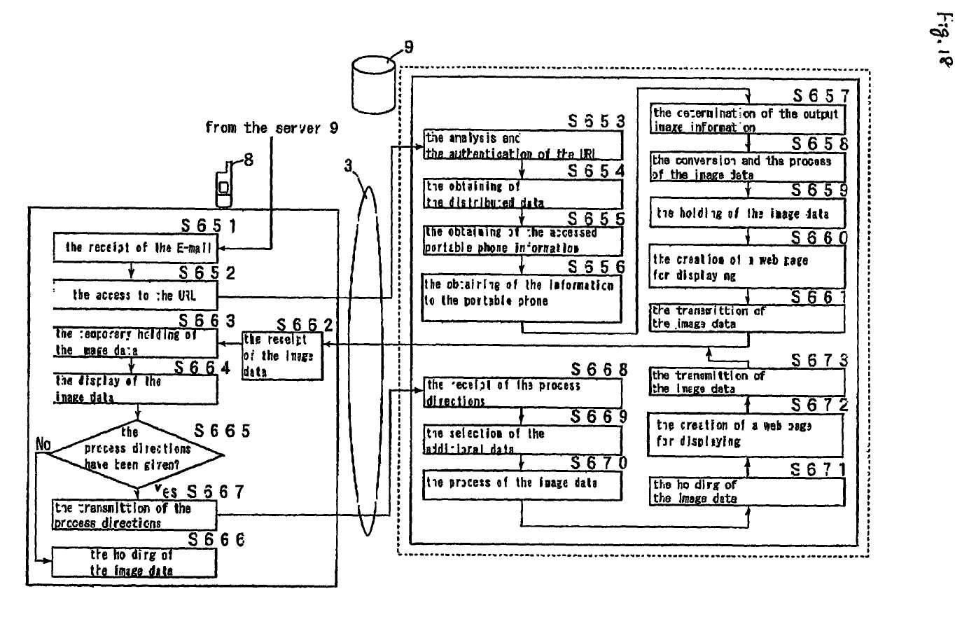

FIG. 18 is a flow diagram illustrating the process in which the receiving party receives the original image and processes the image from server 9 with the portable phone 8. The portable phone 8 of the receiving party receives the electronic mail transmitted by the server in step S610 (step S651). The receiving party accesses the Web site of the URL indicated in the electronic mail (step S652). The server 9 performs an analysis of the URL and authenticates of the user (step S653). Next, the server 9 obtains the image data transmitted by the user from the transmitting image table 27 (step S654). Further, the server 9 obtains information of the portable phone 8 which has accessed (step S655) and obtains distribution information of the portable phone 8 (step S656).

The server 9 determines information of the image data to be outputted (step S657). Next, the server converts or processes the image in view of the information of the portable phone 8 of receiving party and the image data information (step S658). Next, the server 9 holds the image (step S659) and creates a Web page for displaying the image (step S660). Next, the server 9 transmits the image to the portable phone 8 (step S661). The portable phone 8 receives the image data from the server 9 (step S662), temporally holds the image (step S663), and has the image displayed on the display section of the portable phone 8 (step S664).

Next, the portable phone 8 determines whether process directions to process the displayed image (this is to be the original image) have been given or not from the other user (step S665). Without the process directions given, the portable phone 8 holds the image (step S666), to finish the process. On the other hand, when the process directions are given, the portable phone 8 transmits the process directions from the other user to the server 9 (step S667). Then the server 9 receives the process directions (step S668). Next, the server 9 selects additional data to be added to the original image (step S669). This selection is made based on information on the other user's portable phone and the process directions from the other user and so on. And the server 9 carries out a processing process to append the additional data to the original image (step S670).

Next, the server 9 holds the obtained image in step S670 (this is referred to as the process image in a transmitting image table 27 (step S671) followed by creating a Web page for displaying the image (step S672), transmitting the process image to the portable phone 8 (step S673). Next, the portable phone 8 receives the process image (step S662). Steps following step S662 are same as the previously described steps. That is, when the other user desires to process the process image furthermore, each process from step S665 to step S673 is to be repeated.

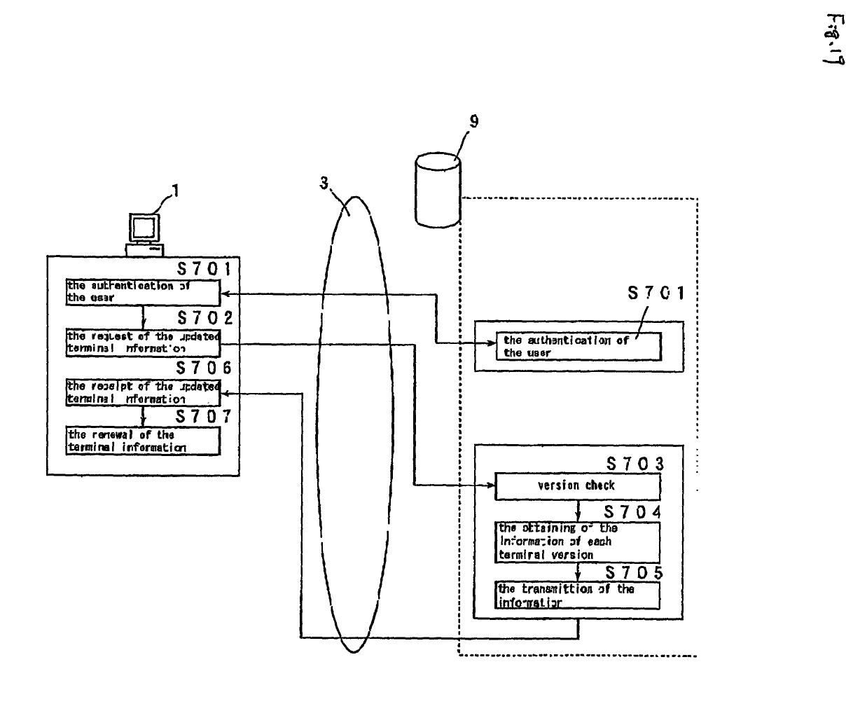

FIG. 19 is a diagram illustrating a flow of process for the user terminal 1 obtaining terminal version information. First, a user accesses the server 9 through the user terminal 1 and carries out authentication of the user (step S701). Next, the user requests the server 9 for the updated terminal information (step S702). The server 9 checks on the terminal version (step S703), and obtains information of each version and data of advertisement (step S704). Server 9 transmits the information of each version and the data of advertisement to the user terminal 1 (step S705). The user terminal 1 receives the above mentioned data transmitted from the server 9 (step S706) and renews the terminal information (step S707).

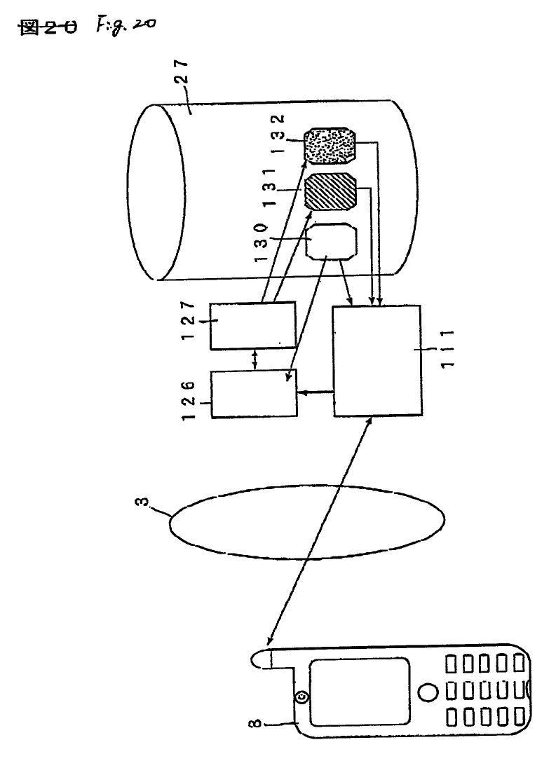

FIG. 20 is a view for explaining a process in which the other user has an original image 130 received by the portable phone 8 processed into a screen of different colors at the server 9 and receives the processed images 131, 132 which have been processed again. When the other user designates a URL displayed at the portable phone 8, the original image 130 held at the transmitting image table 27 of the server 9 is received at the portable phone 8 through the data transmitting/receiving section 111. When the color of the original image 130 is desired to change, the other user designates a color of interest to the server 9. Then the designation is transmitted to an image process section 126 through the data transmitting/receiving section 111. The image process section 126 reads the original image 130 out from the transmitting image table 27 and changes colors to form a different image (process image) 131. Next, a second image holding process section 127 holds the processed image 131 at the transmitting image table 27. Next, the processed image 131 is transmitted to the portable phone 8 through the data transmitting/receiving section 111.

When the other user wishes to process the processed image 131 further more, the image process section 126 performs a similar process to that of the original image 130 to form a different processed image 132. The processed images 131, 132 also are held at the transmitting image table 27 in addition to the original image 130. Incidentally, in the processing process after the second time the original image 130 may be processed or the very previous process image may be processed. That is, the processed image 132 may be an image processed based on the original image 130 or may be an image processed based on the processed image 131.

Thus, the other user can obtain images to which various alternations are added only by giving directions to the server 9 without having software for image processing in his or her own portable phone 8. Therefore, it is possible to improve a processing speed of image compared to a case of image processing with the portable phone 8. Moreover, since all the operation needs to be conducted is directing conditions of processing on the portable phone 8, operations conducted by the other user are simplified.

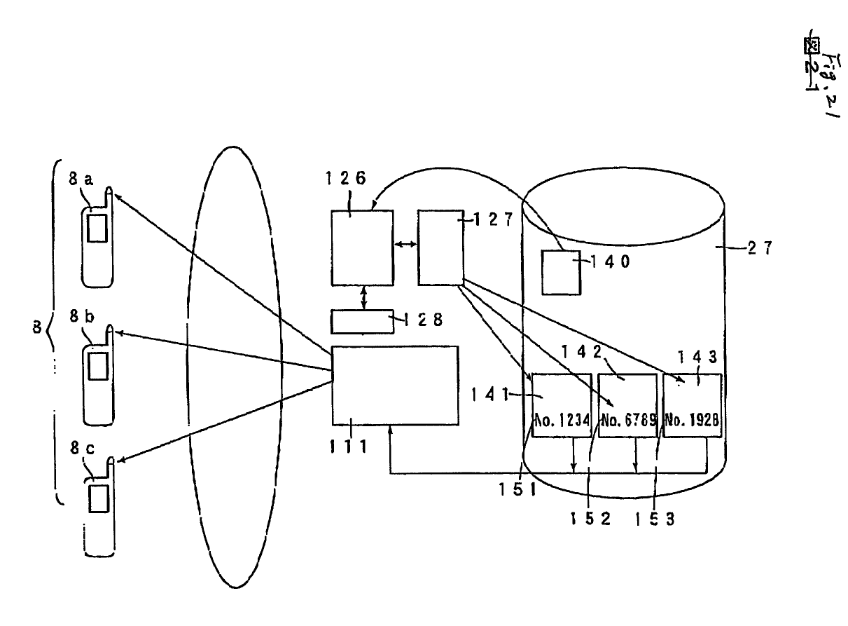

FIG. 21 is a view for explaining a process in which a server 9 transmits a plurality of processed images 141, 142, 143 which are obtained by subjecting an original image 140 to different processes to portable phones 8a, 8b, 8c, respectively. An image process section 126 reads out the original image 140 from the transmitting image table 27, while an additional data selection section 128 selects additional data 151, 152, 153 decided according to the other user. The additional data 151, 152, 153 is read out from an additional data holding section which is not shown. Next, the image process part 126 performs a process to add the additional data 151, 152, 153 transmitted from the additional data selection section 128 to the original image 140.

Next, the second image holding process section 127 holds processed images 141, 142, 143 at the transmitting image table 27. The processed image 141 herein is an image in which the additional data 151 is added to the original image 140. Moreover, the processed image 142 is an image in which the additional data 152 is added to the original image 140. Further, the processed image 143 is an image in which the additional data 153 is added to the original image 140. Next, the processed images 141, 142, 143 are transmitted to portable phones 8a, 8b, 8c to which they are to be transmitted, respectively, through the data transmitting/receiving section 111.

Thus, the server 9 is capable of transmitting different processed images 141, 142, 143 to the plurality of the portable phones 8a, 8b, 8c. Therefore, the process image 141 and so on is available as an image being attached with a lottery for a prize. Moreover, it is possible to send the processed image 141 etc. with the other user's name in.

Moreover, an information recording medium having a saved program including an image process directions receiving step (step S668) to receive directions to process an image from the portable phone 8, an image process step (step S669) to process the image based on the process directions, and an image transmitting step (step S673) to transmit the process image which has been processed in the image process step to the portable phone 8 is inserted to the server 9, thereby the internal program may be executed. Further, the program further including a second image holding process step (step S671) to have the image held, wherein in the image process step (step S670) the image is read in and processed and in the second image holding process step (step S671) the information recording medium may hold the process image at the storage location.

Moreover, one image is transmittable to a plurality of portable phones 8. An information recording medium having a stored program including an additional data selection step (step S669) to select additional data each of the plurality of the portable phones 8, an image process step (step S670) to make the process image in which the additional data is added to the image, and image transmitting step (step S673) to transmit the process image to respective portable phone 8 according to the additional data, is inserted to the server 9, whereby the internal program may be executed.

Moreover, the processing of the image is not limited to alternation of colors in the image background or appendage of numbers. It also includes alternation of colors of human hairstyle, alternation of human in size and other alternations such as a change of background itself.

As the foregoing, the image processor, the image processing method, the image processing system and the information recording medium according to the present invention are useful to transmit an image so as to fit in a portable phone screen of a receiving party, and further to safely transmit the image to the receiving party. Moreover, the image processor, the image processing method, the image processing system and the information recording medium according to the present invention are useful for a receiver of image data without the receiving device having image processing capabilities and further in transmitting image to a plurality of user they are useful to transmit images with slight changes each person.

What is claimed is:

1. An image processor comprising:
a model designation controller for designating a model type of a portable terminal to which an image is to be displayed,
a screen format controller for determining at least one screen format among a plurality of screen formats of the designated model, data capacity and data format of the image,
a image adjuster for adjusting the image, and
a transmitter for transmitting the adjusted image to a server to which the portable terminal of a receiving party has access.

2. The image processor according to claim 1 further comprising:
a virtual portable terminal display for displaying a virtual portable terminal, and
a screen display for displaying a screen of the virtual portable terminal in accordance with the screen format determined by the screen format controller,
wherein in the image adjuster the image is adjusted in accordance with the screen of the virtual portable terminal.

3. An image processor comprising:
a model designation controller for designating a model type of a portable terminal of a receiving party to which an image is to be displayed,
a virtual portable terminal display for displaying a virtual portable terminal of the model designated by the model designation controller,
an image adjuster for adjusting the image on the screen of the virtual portable terminal, and
a transmitter for transmitting the adjusted image to a server to which the portable terminal of the receiving party has access.

4. The image processor according to claim 2 wherein the portable terminal of the receiving party is a portable phone and the virtual portable terminal is a representation of a portable phone.

5. An image processor comprising:
an image formatting controller for formatting an image in accordance with a format of a screen display of a portable terminal to fit in the screen display of the portable terminal.
an image storage device for storing the image as a file designated by a Uniform Resource Locator(URL), and
a transmitter for transmitting the file to the portable terminal.

6. An image processor comprising:
a file formatting controller formatting a file designated by a Uniform Resource Locator(URL), wherein the file includes an image and information capable of magnifying or reducing the image so as to fit in a screen display of a portable terminal to which the image is transmitted.
a transmitter for transmitting the file to the portable terminal.

7. The image processor according to claim 5, wherein the transmitter transmits the URL to a subscriber that created the image as well as transmitting the URL to an email address specified by the subscriber.

8. The image processor according to claim 1, further comprising a storage device for storing the image transmitted to the portable terminal of the receiving party.

9. A image processing method comprising the steps of:
a model designation step for designating a model type of a portable terminal of a receiving party to which an image is to be transmitted,
a screen format determination step for determining at least a screen format among a plurality of screen formats for the designated model, data capacity, and data format of the image,
an image adjusting step for adjusting the image, and
a transmitting step for transmitting the adjusted image to a server to which the portable terminal of the receiver has access.

10. The image processing method according to claim 9 further comprising the steps of:
a virtual portable terminal display step for displaying a virtual portable terminal, and
a screen display step for displaying the screen format of the virtual portable terminal in accordance with the screen format determined by the screen format determination step,
wherein in the image adjusting step the transmitted image is adjusted in accordance with the screen format of the virtual portable terminal.

11. An image processing method comprising the step of:
a model designation step for designating a model type of a portable terminal of a receiving party to which an image is to be transmitted,
a virtual portable terminal display step for displaying a virtual portable terminal of the designated model,
an image adjusting step for adjusting the image on the screen of the virtual portable terminal, and
a transmitting step for transmitting the adjusted image to a server to which the portable terminal of the receiving party has access.

12. The image processing method according to claim 11 further comprising the step of storing the transmitted image.

13. An image processing method comprising the steps of:
an image formatting step for formatting an image in accordance with a format of a screen display of a portable terminal to which the image is to be transmitted,
an image storing step for storing the image as a file designated by a Uniform Resource Locator(URL), and
a transmitting step of transmitting the file to the portable terminal.

14. An image processing method comprising the steps of:
a file forming step for inputting information capable of magnifying or reducing an image so as to fit in a screen display of a portable terminal to which the image is to be transmitted along with a file designated by a URL, and
a transmitting step for transmitting the file to the portable terminal.

15. The image processing method according to claim 13 wherein in the transmitting step the URL is transmitted to a subscriber who created the image and to an address specified by the subscriber.

16. The image processing method according to claim 9 further comprising a storage step for storing the transmitted image.

17. An information recording medium having a stored program comprising the steps of:
a model designation step for designating a model type of a portable terminal of a receiving party to which an image is to be transmitted,
a screen format determination step for determining at least one screen format among a plurality of screen formats for the designated model, data capacity, and data format of image,
an image adjusting step for adjusting the image, and
a transmitting step for transmitting the adjusted image to a server to which the portable terminal of the receiving party has access.

18. The information recording medium according to claim 17 further including the steps of:
a virtual portable terminal display step for displaying a virtual portable terminal, and
a screen display step of displaying the virtual portable terminal in accordance with the screen format determined by the screen format determination step,
wherein in the image adjusting step, the image is adjusted in accordance with the screen format of the virtual portable terminal.

19. An information recording medium having a stored program comprising the steps of:
a model designation step for designating a model type of a portable terminal of a receiving party to which an image is to be transmitted,
a virtual portable terminal display step for displaying a virtual portable terminal of the designated model,
an image adjusting step for adjusting the image on the screen format of the virtual portable terminal, and
a transmitting step of transmitting the adjusted image to a server to which the portable terminal of the receiving party has access.

20. The information recording medium according to claim 19 further comprising the step of storing the transmitted image.

21. An information recording medium having a stored program comprising the steps of:
an image forming step of forming an image in accordance with a format of a screen display of a portable terminal to which the image is to be transmitted,
an image storing step of storing the image as a file designated by a URL, and
a transmitting step of transmitting the file to the portable terminal.

22. An information recording medium having a stored program comprising the steps of:
a file forming step for inputting information capable of magnifying or reducing an image so as to fit in a screen display of a portable terminal to which the image is to be transmitted along with a file designated by a Uniform Resource Locator(URL), and
a transmitting step of transmitting the file to the portable terminal.

23. The information recording medium according to claim 21 wherein in the transmitting step the URL is transmitted to a subscriber who created the image and to an address specified by the subscriber.

24. The information recording medium according to claim 17, further including a storage step of storing the image.

25. An image processing system comprising:
an image processor transmitting an image and transmitter information,
a portable terminal receiving the image through the Internet, and
a server having an address forming controller for appending the transmitter information and forming an address locating a storage location of the image, an address transmitter for transmitting the address to the portable phone and an image transmitter for transmitting the image to the storage location,
wherein the portable terminal accesses the transmitted address and downloads the image at the transmitted address to be a standby screen of the portable phone.

26. An information processing system comprising:
an image processor comprising:
a receiver for receiving transmitter information,
an address forming controller for appending the transmitter information and forming an address locating a storage location of an image, and
an image processor transmitter for transmitting the image and the address, and
a server for receiving the transmitted image and address, wherein said server has an address transmitter for transmitting the address to the portable terminal, and a storage for storing the transmitted image,
wherein the portable terminal accesses the transmitted address and downloads the image corresponding to the transmitted address from the address transmitter to be a standby screen of the portable terminal.

27. An image processing system comprising:
a receiver for receiving transmitter information,
an address forming controller for appending the transmitter information and forming an address locating a storage location of the image,
an image transmitter for transmitting the image and the address, and
an address transmitter for transmitting the address to the portable terminal;
wherein the transmitter information is selected from the group consisting of an ID and password for identifying a transmitter.

28. An image processor comprising:
a receiver for receiving processing directions of an image from a portable terminal of a receiving party to which the image is to be transmitted,
an image processor controller for processing the image based on the processing directions, and
an image transmitter for transmitting the processed image which has been processed by the image processor controller to the portable terminal of the receiving party.

29. The image processor according to claim 28 further comprising:
a first storage device for storing the image, and
a second storage device for storing the processed image, wherein the image processor controller reads in the image from the first image storage device processes it, and stores it in the second storage device.

30. The image processor according to claim 28 wherein the image processing controller carries out a color variation process to change colors of the image and an addition process to add data selected from the group consisting of characters, symbols and devices to the image.

31. An image processor comprising:
a data selector for selecting data from the group consisting of arbitrary characters, symbols and devices each for a plurality of portable terminals,
an image processor controller for processing images in which the data is added to the images, and
an image transmitter for transmitting a processed image to each of the plurality of the portable terminals, according to the added data.

32. An image processing method comprising the steps of:
receiving processing directions for an image from a portable terminal of a receiving party to which the image is to be transmitted,
an image processing step for processing the image based on the processing directions, and
an image transmitting step of transmitting the processed image processed in the image processing step to the portable terminal of the receiving party.

33. The image processing method according to claim 32 further comprising a first storing step for storing the image a second storing step for storing the image after being processed by the image processing step.

34. The image processing method according to claim 32 wherein in the image processing step a color variation process to change colors of the image and an addition process to add data selected from the group consisting of characters, symbols and devices to the image is carried out.

35. An image processing method comprising the steps of:
a data selection step of selecting data from the group consisting of arbitrary characters, symbols and devices for each of a plurality of portable terminals,
an image processing step of forming processed images in which the data is added to the images, and
an image transmitting step of transmitting a processed image to each of the plurality of the portable terminals, according to the added data.

36. An image processing system comprising:
a portable terminal of a receiving party to which an image is to be transmitted,
a server in communication with the portable terminal of the receiving party through communication channels and capable of transmitting the image,
wherein the server processes the image upon receipt of the processing directions of the image from the portable terminal of the receiving party and transmits the processed image to the portable terminal of the receiving party.

37. The image processing system according to claim 36 wherein the server reads and processes the image, stores a copy of the processed image, and transmits the processed image to the portable terminal of the receiving party.

38. The image processing system according to claim 36 wherein the server carries out a color variation process to change colors of the image and an addition process to add data selected from the group consisting of characters, symbols and devices to the image.

39. An image processing system comprising:
a plurality of portable terminals for a plurality of receiving parties to which an image is to be transmitted,
a server in communication with the plurality of portable terminals through a communication terminal and capable of transmitting the image upon receipt of directions from the plurality of the portable terminal,
wherein the server selects additional data selected from the group consisting of arbitrary characters, symbols and devices for each of the plurality of the portable terminals and forms processed images in which the additional data is added to the image, and transmits the processed image to each of the plurality of the portable terminals according to the additional data.

40. An information recording medium having a stored program comprising the steps of:
receiving processing directions for an image from a portable terminal of a receiving party to which the image is transmitted,
an image processing step for processing the image based on the processing directions, and
an image transmitting step of transmitting the processed image which has been processed in the image processing step to the portable terminal of the receiving party.

41. The information recording medium according to claim 40 further comprising the steps of:
an image storing process step for storing the image, wherein in the image processing step the image is read and subjected to processing and in the image storing step the processed image is stored at a storage location.

42. The information recording medium according to claim 40 wherein in the image processing step a color variation process to change colors of the image and an addition process to add data selected from the group consisting of characters, symbols and devices to the image is carried out.

43. An information recording medium having a stored program comprising the steps of:
a data selection step for selecting data selected from the group consisting of arbitrary characters, symbols and devices each for a plurality of portable terminals,
an image processing step for forming processed images in which the data is added to each of the images, and
an image transmitting step of transmitting a processed image to each of the plurality of portable terminals according to the added data.

44. An image processor comprising:
a model designation mean for designating a model type of a portable terminal to which an image is to be displayed,
a screen format mean for determining at least one screen format among a plurality of screen formats of the designated model, data capacity and data format of the image,
a image adjusting means for adjusting the image, and
a transmitting means for transmitting the adjusted image to a server to which the portable terminal of a receiving party has access.

45. The image processor according to claim 44 further comprising:
a virtual portable terminal display means for displaying a virtual portable terminal, and
a screen display means for displaying a screen of the virtual portable terminal in accordance with the screen format determined by the screen format means,
wherein in the image adjusting means the image is adjusted in accordance with the screen of the virtual portable terminal.
